(19) United States
(12) Patent Application Publication
(10) Pub. No.: US 2012/0040264 A1
(43) Pub. Date: Feb. 16, 2012

(54) HYDROGEN CONCENTRATION SENSOR UTILIZING CELL VOLTAGE RESULTING FROM HYDROGEN PARTIAL PRESSURE DIFFERENCE

(75) Inventors: Andrew J. Maslyn, Rochester, NY (US); Balasubramanian Lakshmanan, Pittsford, NY (US)

(73) Assignee: GM GLOBAL TECHNOLOGY OPERATIONS, INC., DETROIT, MI (US)

(21) Appl. No.: 12/854,832

(22) Filed: Aug. 11, 2010

(51) Int. Cl. H01M 8/04; G01M 15/10; H01M 8/24

(52) U.S. Cl. 429/432; 429/452; 73/23.31

(57) ABSTRACT

A hydrogen concentration sensor for measuring the hydrogen concentration in an anode sub-system of a fuel cell system. The hydrogen concentration sensor includes a membrane, a first catalyst layer on one side of the membrane and a second catalyst layer on an opposite side of the membrane where the sensor operates as a concentration cell. The first catalyst layer is exposed to fresh hydrogen for the anode side of a fuel cell stack and the second catalyst layer is exposed to an anode recirculation gas from an anode exhaust of the fuel cell stack. The voltage generated by the sensor allows the hydrogen partial pressure in the recirculation gas to be determined, from which the hydrogen concentration can be determined.

### BACKGROUND OF THE INVENTION

1. Field of the Invention

This invention relates generally to a hydrogen concentration sensor that determines the concentration of hydrogen in an anode sub-system of a fuel cell system and, more particularly, to a hydrogen concentration sensor that determines the concentration of hydrogen in an anode sub-system of a fuel cell system that employs anode exhaust gas recirculation, where the Nernst equation is used to determine the hydrogen partial pressure in the recirculation gas from the hydrogen concentration sensor voltage output and the hydrogen partial pressure is used to determine the hydrogen concentration in the recirculation gas.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack. The stack also includes flow channels through which a cooling fluid flows.

The fuel cell stack includes a series of bipolar plates positioned between several MEAs in the stack, where the bipolar plates and the MEAs are positioned between the two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

MEAs are permeable and thus allow nitrogen in the air from the cathode side of the stack to permeate through and collect in the anode side of the stack, referred to in the industry as nitrogen cross-over. Even though the anode side pressure may be higher than the cathode side pressure, the cathode side partial pressures will cause air to permeate through the membrane. Nitrogen in the anode side of the fuel cell stack dilutes the hydrogen such that if the nitrogen concentration increases beyond a certain percentage, such as 50%, the fuel cell stack becomes unstable and may fail. It is known in the art to provide a bleed valve at the anode exhaust gas output of the fuel cell stack to remove nitrogen from the anode side of the stack.

It is desirable to predict or estimate the amount of hydrogen in the anode and cathode of a fuel cell system during system start-up to allow the start-up strategy to meet emissions requirements while maximizing reliability and minimizing start time. It is further desirable to estimate the hydrogen concentration in the anode during normal operation, vehicle idle, and all other operating modes of the vehicle to better control the bleeds and maximize fuel efficiency while minimizing stack damage. It is generally desirable that the hydrogen concentration estimator be robust to shut-down and off time related functions and account for membrane permeation of gases as well as air intrusion from external sources. At the same time, the estimation algorithm must be simple enough to be provided in an automotive controller with the calculation sufficiently minimal so as to be completed without delaying the start-up.

Determining the hydrogen concentration in the anode and cathode of the fuel cell stack at start-up will allow the fastest possible start time because the system control does not need to provide excess dilution air when unnecessary. Further, knowing the hydrogen concentration provides a more reliable start because the amount of hydrogen in the anode that needs to be replenished will be known. This is especially relevant for start-ups from a stand-by state, or from the middle of a shut-down, where hydrogen concentrations can be relatively high.

Further, knowing the hydrogen concentration improves durability because when there is an unknown hydrogen concentration in the stack, typical start-up strategies assume the worst case percentage of hydrogen for injection purposes and 100% hydrogen for dilution purposes. In those situations, the initial anode flush with hydrogen could be slower than if the stack is known to be filled with air. The rate of corrosion is proportional to the initial hydrogen flow rate. Therefore, without accurately knowing the hydrogen concentration, each of these events will be more damaging than necessary.

Also, knowing the hydrogen concentration provides improved efficiency because a more accurate determination of hydrogen concentration in the anode and cathode prior to start-up will lead to more effective start-up decisions and potential reduction in hydrogen uses. For example, dilution air could be lowered if it is known that the stack is starting with no hydrogen in it. Further, knowing the hydrogen concentration provides more robust start-ups. In the event of a premature shut-down or a shut-down with a failed sensor, the algorithm can use physical limits to provide an upper and lower bound on the hydrogen in the cathode and anode.

An algorithm may be employed to model an online estimation of the hydrogen and/or nitrogen concentration in the anode during stack operation to know when to trigger the anode exhaust gas bleed. The algorithm may track the nitrogen concentration over time in the anode side of the stack based on the permeation rate from the cathode side to the anode side, and the periodic bleeds of the anode exhaust gas. When the algorithm calculates an increase in the nitrogen concentration above a predetermined threshold, for example 10%, it may trigger the bleed. This bleed is typically performed for a duration that allows multiple stack anode volumes to be bled, thus reducing the nitrogen concentration below the threshold. However, known hydrogen estimation models have typically been relatively inaccurate due to increases in gas cross-over rate as the stack ages.

It is known in the art to provide a hydrogen concentration sensor in an anode exhaust gas recirculation loop that measures the concentration of hydrogen in the anode exhaust to determine whether a bleed is necessary. However, known hydrogen sensors of this type are susceptible to water droplets, which require liquid water separators in the exhaust in order to allow the sensors to operate properly. Further, there is a measurement delay due to the volume the exhaust gas must travel to reach the sensor, which can be on the order of fifteen seconds.

One known hydrogen concentration sensor is known as a thermal conductivity detector (TCD) that uses the known thermal conductivity of gases to calculate the hydrogen concentration. The TCD needs to be calibrated in whatever environment it is being used in, here a hydrogen-nitrogen environment. The TCD also requires a very robust and efficient method for removing all of the water from the gas that is being detected before it is measured because water will cause the sensor to fail. This requires the use of significant plumbing and water separation devices that add volume to the system and generally provides an unacceptable time delay to the measurement.

These sensors also are fairly expensive where the system typically employs two sensors, one in the anode inlet manifold and one in the anode outlet manifold. Because the nitrogen buildup typically occurs very rapidly at high power transients, which may be limited in time, the delay in the sensor reading may cause the hydrogen concentration measurement to not be available during the power up-transient when the nitrogen concentration is the highest.

### SUMMARY OF THE INVENTION

In accordance with the teachings of the present invention, a hydrogen concentration sensor is disclosed for measuring the hydrogen concentration in an anode sub-system of a fuel cell system. The hydrogen concentration sensor includes a membrane, a first catalyst layer on one side of the membrane and a second catalyst layer on an opposite side of the membrane where the sensor operates as a concentration cell. The first catalyst layer is exposed to fresh hydrogen for the anode side of a fuel cell stack and the second catalyst layer is exposed to an anode recirculation gas from an anode exhaust of the fuel cell stack. The voltage generated by the sensor allows the hydrogen partial pressure in the recirculation gas to be determined, from which the hydrogen concentration can be determined.

Additional features of the present invention will become apparent from the following description and appended claims, taken in conjunction with the accompanying drawings.

### BRIEF DESCRIPTION OF THE DRAWINGS

FIG. 1 is a schematic plan view of a fuel cell system;

FIG. 2 is a perspective view of a hydrogen concentration sensor assembly;

FIG. 3 is a front view of a series of hydrogen concentration sensors electrically coupled together on a common substrate in the sensor assembly shown in FIG. 2; and

FIG. 4 is a cross-sectional view of one of the sensors in the sensor array shown in FIG. 3.

### DETAILED DESCRIPTION OF THE EMBODIMENTS

The following discussion of the embodiments of the invention directed to a hydrogen concentration sensor for a fuel cell system is merely exemplary in nature, and is in no way intended to limit the invention or its applications or uses.

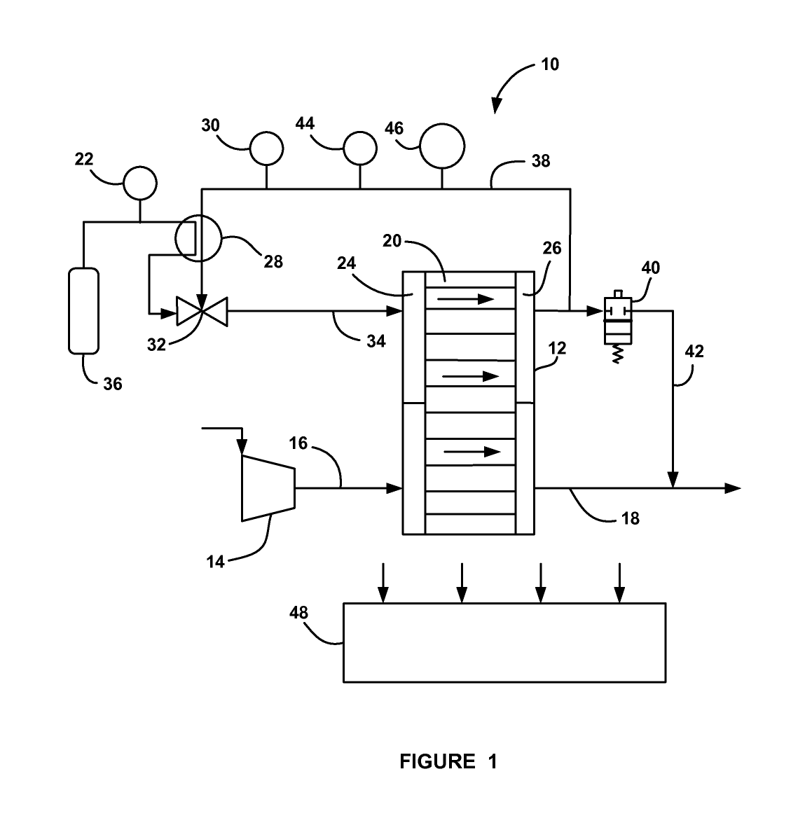

FIG. 1 is a schematic plan view of a fuel cell system 10 including a fuel cell stack 12 having fuel cells 20. A compressor 14 provides compressed air to the cathode side of the fuel cell stack 12 on a cathode input line 16. A cathode exhaust gas is output from the fuel cell stack 12 on a cathode exhaust gas line 18. An injector 32 injects hydrogen gas from a hydrogen source 36, such as a high pressure tank, into the anode side of the fuel cell stack 12 on an anode input line 34 through an anode inlet manifold 24. The fresh hydrogen from the source 36 is also sent through a hydrogen concentration sensor assembly 28, discussed in detail below. A pressure sensor 22 measures the pressure of the fresh hydrogen gas provided to the injector 32. Anode exhaust gas from an anode outlet manifold 26 in the fuel cell stack 12 is recirculated back to the injector 32 on a recirculation line 38. It is understood in the industry that a device is needed to enable the recirculation of hydrogen which is not shown in FIG. 1. As is well understood in the art, it is periodically necessary to bleed the anode exhaust gas to remove nitrogen from the anode side of the stack 12. A bleed valve 40 is provided in an anode exhaust line 42 for this purpose, where the bled anode exhaust gas is combined with the cathode exhaust gas on the line 18 to dilute hydrogen within the anode exhaust gas to be below combustible and/or emissions limits.

The hydrogen concentration sensor assembly 28 receives a flow of the anode recirculation gas in the recirculation line 38 and the flow of fresh hydrogen from the source 36 before it is sent to the valve 32, and provides a measurement of the concentration of hydrogen gas in the anode sub-system, as will be discussed in detail below. A pressure sensor 44 provides a measurement of the pressure of the recirculation gas in the recirculation line 38. A temperature sensor 30 measures the temperature of the gas flowing in the anode sub-system, here specifically the recirculation line 38. Also, a relative humidity (RH) sensor 46 measures the relative humidity of the anode recirculation gas in the line 38. In alternate embodiments, the relative humidity of the anode recirculation gas can be obtained in other ways known to those skilled in the art. A controller 48 receives the various sensor measurements discussed herein, including a voltage measurement from the sensor assembly 28, pressure measurements from the pressure sensors 22 and 44, the temperature measurement from the temperature sensor 30 and the relative humidity measurement from the RH sensor 46, and calculates the concentration of hydrogen gas in the recirculation line 38 consistent with the discussion below.

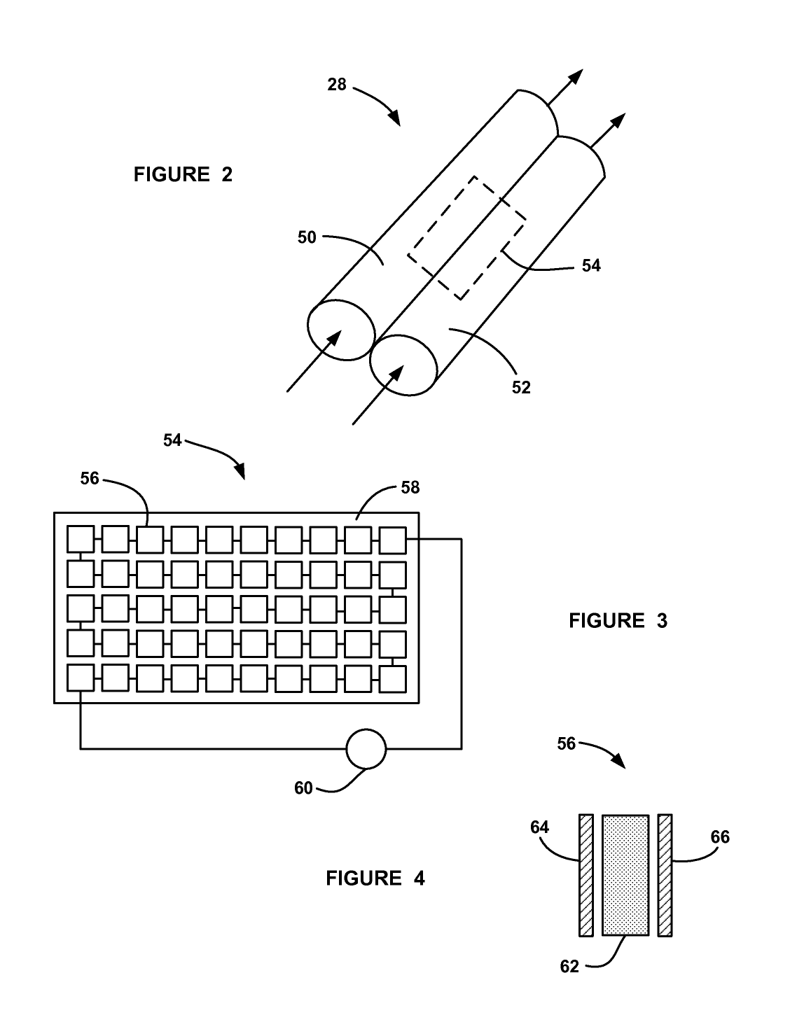

FIG. 2 is a perspective view of the hydrogen concentration sensor assembly 28 removed from the system 10. The sensor assembly 28 includes a first flow path 50 through which the fresh hydrogen gas from the source 36 flows and a second flow path 52 through which the anode recirculation gas flows. The depiction and design of the hydrogen concentration sensor assembly 28 as shown is by way of a non-limiting example in that any suitable configuration of flow paths can be employed consistent with the discussion herein. The sensor assembly 28 further includes a sensor array 54, which is shown removed from the sensor assembly 28 in FIG. 3. The sensor array 54 includes a plurality of hydrogen concentration sensors 56, here fifty sensors shown by way of a non-limiting example, configured on a substrate 58 and electrically coupled in series. In an alternate embodiment, the sensors 56 can be electrically coupled in parallel. A voltage meter 60 measures the voltage potential provided by all of the series connected sensors 56. FIG. 4 is a cross-sectional view of one of the sensors 56 separated from the array 54. The sensor 56 includes a relatively thick membrane 62, such as a perfluorosulfonic membrane as employed in the stack 12, where the thickness of a membrane 62 is relatively thick and may be about 150 μm. A first catalyst layer 64 is provided at one side of the membrane 62 and a second catalyst layer 66 is provided at an opposite side of the membrane 62.

The sensor array 54 is positioned between the flow paths 50 and 52 so that the catalyst layers 64 in all of the sensors 56 are exposed to the hydrogen flow through the flow path 50 and the catalyst layers 66 in all of the sensors 56 are exposed to the anode recirculation gas in the flow path 52. In this manner, one side of all of the sensors 56 is exposed to one of the flows and the other side of all of the sensors 56 is exposed to the other flow. The sensors 56 operate as hydrogen-hydrogen concentration cells where the cell potential of the cell is determined by the partial pressure of hydrogen on either side of the membrane. Particularly, the catalyst layers 64 and 66 electro-chemically react within the hydrogen gas in the flows so that a voltage potential is provided between the catalyst layer 64 and 66.

Because the concentration of the hydrogen gas flowing through the flow path 50 including the fresh hydrogen is greater than the concentration of the hydrogen gas flowing through the flow path 52 including the recirculation gas, the voltage for electro-chemical reaction will be greater on the fresh hydrogen side of the sensors 56 depending on the pressure. The voltage potential V is the voltage difference between the catalyst layers 64 and 66 that is used to determine the concentration of the hydrogen gas in the anode recirculation gas. Because the gas from the hydrogen source 36 is nearly pure hydrogen, the pressure sensor 22 provides a measurement of the hydrogen gas in the flow path 50. Using the measured voltage potential V, the pressure of the hydrogen gas in the flow path 50 and the known Nernst equation, shown as equation (1) below, the partial pressure of the hydrogen gas in the recirculation line 38 flowing through the flow path 52 can be determined. By knowing the hydrogen partial pressure in the recirculation line 38, the hydrogen gas concentration can be determined.

$$V = 2.303 \cdot \frac{RT}{zF} log ( \frac{{AnP}_{{H}_{2}}}{{CaP}_{{H}_{2}}} ) \qquad ( 1 )$$

Where R is the universal gas constant 8.314 J/molK, z is electron exchange and is 2 in this calculation, F is Faraday's constant of 96485 C/mol, T is the temperature of the anode recirculation gas in K, AnP_{H}, is the fresh hydrogen gas pressure and CaP_{H}, is the hydrogen partial pressure in the recirculation gas with units of kPa. In this representation, the recirculation gas side of the sensor assembly 28 is referred to as the cathode (Ca) side because it has a lower hydrogen partial pressure.

The Nernst equation defines about a 35 V of cell voltage per decade of hydrogen partial pressure difference. To exaggerate this voltage difference, multiple sensors are employed as discussed that are connected in series resulting in an amplified voltage difference, where in one non-limiting embodiment, each sensor 56 has an active area less than a centimeter squared. Multiple sensors can also be placed in a parallel array to increase the robustness and reliability of the sensor against various disturbances from the system including, but not limited to, liquid water droplets.

Rearranging equation (1) allows the hydrogen partial pressure in the recirculation gas CaP_{H}_{₂} to be calculated as:

$${CaP}_{{H}_{2}} = \frac{{AnP}_{{H}_{2}}}{{10}^{( \frac{VzF}{2.303 RT} )}} \qquad ( 2 )$$

The hydrogen concentration H₂Conc in the recirculation gas can then be calculated as:

$${H}_{2} Conc = \frac{{CaP}_{{H}_{2}}}{P - RH \cdot {P}_{sat}} \qquad ( 3 )$$

Where RH is the relative humidity of the recirculation gas, P is the total pressure of the recirculation gas and Pₛₐₜ is the saturation pressure of the recirculation gas calculated as:

Pₛₐₜ=(1.45E⁻⁴·T³)−(6.11E⁻³·T²)+(1.60E⁻¹·T)+(6.00E⁻¹) (4)

At a relative humidity between 20% and 100% and temperatures between 30° C. and 80 C.° in the anode sub-system, there exists at least a 100 mV signal with respect to a 20% drop in the hydrogen gas concentration, which is easily recognized by software and usable as a trigger for an anode bleed as well as hydrogen concentration when the system is in park.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack including an anode side;
a hydrogen source providing fresh hydrogen gas on an anode input line to the anode side of the fuel cell stack;
an anode exhaust gas recirculation line receiving an anode exhaust gas from the fuel cell stack and providing an anode recirculation gas to the anode input line and the anode side of the fuel cell stack; and
a hydrogen concentration sensor assembly in communication with the anode input line and the anode exhaust gas recirculation line, said hydrogen concentration sensor assembly including at least one hydrogen concentration sensor operating as a concentration cell having a membrane, a first catalyst layer on one side of the membrane and a second catalyst layer on an opposite side of the membrane, where the first catalyst layer is exposed to the fresh hydrogen gas from the hydrogen source and the second catalyst layer is exposed to the anode recirculation gas in the anode recirculation gas line.

2. The fuel cell system according to claim 1 wherein the at least one hydrogen concentration sensor is a plurality of hydrogen concentration sensors electrically coupled in series.

3. The fuel cell system according to claim 1 wherein the at least one hydrogen concentration sensor is a plurality of hydrogen concentration sensors electrically coupled in parallel.

4. The fuel cell system according to claim 1 wherein the membrane in the hydrogen concentration sensor has a thickness of about 150 μm.

5. The fuel cell system according to claim 1 further comprising a controller receiving a voltage potential from the hydrogen concentration sensor assembly, said controller being configured to determine the hydrogen partial pressure in the anode recirculation gas using the Nernst equation.

6. The fuel cell system according to claim 5 wherein the controller determines the hydrogen partial pressure in the anode recirculation gas using the equation:
$$V = 2.303 \cdot \frac{RT}{zF} log ( \frac{{AnP}_{{H}_{2}}}{{CaP}_{{H}_{2}}} )$$
where V is the voltage potential, R is the universal gas constant, T is the temperature of the anode recirculation gas, z is electron exchange, F is Faraday's constant, AnP_{H}_{₂} is the pressure of the hydrogen in the anode input line and CaP_{H}_{₂} is the hydrogen partial pressure of the anode recirculation gas.

7. The fuel cell system according to claim 5 wherein the controller determines the concentration of hydrogen in the anode recirculation gas using the hydrogen gas partial pressure in the recirculation gas, the total pressure of the recirculation gas, the saturation pressure of the recirculation gas and the relative humidity of the recirculation gas.

8. The fuel cell system according to claim 7 wherein the controller determines the hydrogen gas concentration in the recirculation gas using the equation:
$${H}_{2} Conc = \frac{{CaP}_{{H}_{2}}}{P - RH \cdot {P}_{sat}}$$
where H₂Conc is the hydrogen gas concentration, CaPH₂ is the hydrogen partial pressure, P is the total pressure in the recirculation gas, RH is the relative humidity of the recirculation gas, and Pₛₐₜ is the saturation pressure of the recirculation gas defined by the equation:
Pₛₐₜ=(1.45E⁻⁴·T³)−(6.11E⁻³·T²)+(1.60E⁻¹·T)+(6.00E⁻¹).

9. A fuel cell system comprising:
a fuel cell stack including an anode side;
a hydrogen source providing fresh hydrogen gas to an input of the anode side of the fuel cell stack;
an anode exhaust gas recirculation line receiving an anode exhaust gas from the fuel cell stack and providing an anode recirculation gas to the input of the anode side of the fuel cell stack;
a first pressure sensor providing a pressure measurement of the fresh hydrogen gas from the hydrogen source provided to the input of the anode side of the fuel cell stack;
a second pressure sensor providing a total pressure measurement of the anode recirculation gas;
a temperature sensor providing a temperature measurement of the anode recirculation gas;
a relative humidity sensor providing a relative humidity measurement of the anode recirculation gas;
a hydrogen concentration sensor assembly receiving a flow of the fresh hydrogen gas from the hydrogen source and a flow of the anode recirculation gas before it is provided to the input of the anode side of the fuel cell stack, said hydrogen concentration sensor assembly providing a voltage potential generated by the difference between the hydrogen gas pressure in the fresh hydrogen gas and the hydrogen partial pressure in the anode recirculation gas; and
a controller responsive to the voltage potential from the hydrogen concentration sensor assembly, the pressure measurement from the first pressure sensor, the pressure measurement from the second pressure sensor, the temperature measurement from the temperature sensor and the relative humidity measurement from the relative humidity sensor, said controller using the measurements to determine the concentration of hydrogen gas in the anode recirculation gas.

10. The system according to claim 9 wherein the controller is configured to determine the partial pressure of the hydrogen gas in the anode recirculation gas using the Nernst equation, the voltage potential and the pressure measurement from the first pressure sensor.

11. The system according to claim 10 wherein the controller determines the hydrogen partial pressure in the anode recirculation gas using the equation:
$$V = 2.303 \cdot \frac{RT}{zF} log ( \frac{{AnP}_{{H}_{2}}}{{CaP}_{{H}_{2}}} )$$
where V is the voltage potential, R is the universal gas constant, T is the temperature of the anode recirculation gas, z is electron exchange, F is Faraday's constant, AnP_{H}_{₂} is the pressure of the hydrogen in the anode input line and CaP_{H}_{₂} is the hydrogen partial pressure of the anode recirculation gas.

12. The system according to claim 10 wherein the controller is configured to determine the concentration of the hydrogen gas in the anode recirculation gas using the partial pressure of the hydrogen gas in the anode recirculation gas, the pressure measurement from the second pressure sensor, the relative humidity measurement from the relative humidity sensor and a saturation pressure of the recirculation gas.

13. The system according to claim 12 wherein the controller determines the hydrogen gas concentration in the recirculation gas using the equation:
$${H}_{2} Conc = \frac{{CaP}_{{H}_{2}}}{P - RH \cdot {P}_{sat}}$$
where H₂Conc is the hydrogen gas concentration, CaPH₂ is the hydrogen partial pressure, P is the total pressure in the recirculation gas, RH is the relative humidity of the recirculation gas, and Pₛₐₜ is the saturation pressure of the recirculation gas defined by the equation:
Pₛₐₜ=(1.45E⁻⁴·T³)−(6.11E⁻³·T²)+(1.60E⁻¹·T)+(6.00E⁻¹).

14. The system according to claim 9 wherein the hydrogen concentration sensor assembly includes at least one hydrogen concentration sensor configured as a concentration cell including a membrane having a first catalyst layer on one side and a second catalyst layer on an opposite side where the first catalyst layer is exposed to the fresh hydrogen gas and the second catalyst layer is exposed to the anode recirculation gas.

15. The system according to claim 14 wherein the at least one hydrogen concentration sensor is a plurality of hydrogen concentration sensors electrically coupled in series and each operating as a fuel cell.

16. The system according to claim 14 wherein the membrane in the hydrogen concentration sensor has a thickness of about 150 μm.

17. A hydrogen concentration sensor assembly for determining the concentration of hydrogen gas in a fuel cell system, said sensor assembly comprising:
a first flow path receiving a flow of fresh hydrogen gas;
a second flow path receiving a flow of gas being partly hydrogen; and
at least one hydrogen concentration sensor mounted on a substrate between the first flow path and the second flow path, said at least one sensor including a membrane, a first catalyst layer on one side of the membrane and a second catalyst layer on an opposite side of the membrane, where the first catalyst layer is exposed to the flow of fresh hydrogen in the first flow path and the second catalyst layer is exposed to the flow of gas being partly hydrogen in the second flow path.

18. The sensor assembly according to claim 17 wherein the membrane in the hydrogen concentration sensor has a thickness of about 150 μm.

19. The sensor assembly according to claim 17 wherein the at least one hydrogen concentration sensor is a plurality of hydrogen concentration sensors each having a membrane, a first catalyst layer and a second catalyst layer and being electrically coupled in series.

20. The sensor assembly according to claim 17 wherein the flow of gas being partly hydrogen is an anode recirculation gas recirculated from an anode exhaust to an anode input.
